(19) United States
(12) Patent Application Publication
(10) Pub. No.: US 2014/0126382 A1
(43) Pub. Date: May 8, 2014

(54) FORWARD LINK ACKNOWLEDGMENT IN A MACHINE-TO-MACHINE WIRELESS WIDE AREA NETWORK

(71) Applicant: QUALCOMM INCORPORATED, San Diego, CA (US)

(72) Inventors: Bin TIAN, San Diego, CA (US); Alok K. GUPTA, San Diego, CA (US)

(73) Assignee: QUALCOMM INCORPORATED, San Diego, CA (US)

(21) Appl. No.: 13/669,714

(22) Filed: Nov. 6, 2012

(51) Int. Cl. H04W 24/00

(52) U.S. Cl. 370/241

(57) ABSTRACT

Methods, systems, and devices are described for managing wireless communications in a machine-to-machine (M2M) wireless Wide Area Network (WAN). An event is detected that indicates a condition of a forward link in the M2M wireless WAN. A data rate is selected to transmit an acknowledgment (ACK) message. The selection of the data rate is based at least in part on the detected event that indicates the condition of the forward link. The ACK message is transmitted on the forward link in the M2M wireless WAN according to the selected data rate.

### BACKGROUND

The following relates generally to wireless communication, and more specifically to communications in a machine-to-machine (M2M) wireless wide area network (WAN). Wireless communications systems are widely deployed to provide various types of communication content such as voice, video, packet data, messaging, broadcast, sensor data, tracking data, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple devices. In some examples, these devices may be sensors and/or meters configured to collect data and transmit this data to an end server via a base station. These sensors and/or meters may be referred to as M2M devices. Base stations may communicate with M2M devices on forward and reverse links. Each base station has a coverage range, which may be referred to as the coverage area of the cell. An M2M device may transmit data to a base station on the reverse link. Upon successfully receiving and decoding the data, the base station may transmit an acknowledgment (ACK) message to the M2M device. The M2M device may continue to transmit the data until the ACK message is received.

One or more of the M2M devices may be located close to the base station than other M2M devices. The proximate location may result in these M2M devices sharing a stronger reverse link and forward link with the base station than the M2M devices that are located a greater distance from the base station. The stronger the reverse and forward link, the higher the data throughput may be for these communications. Transmitting ACK messages at a low data rate when the forward link is strong may result in the M2M devices closer to the base station having to wait an unnecessarily longer duration of time to receive the ACK message. As a result, these M2M devices may unnecessarily continue to transmit their data until the ACK message is received. This may consume power and other resources of the M2M devices.

### SUMMARY

The described features generally relate to one or more improved systems, methods, and/or apparatuses for creating and transmitting an acknowledgment (ACK) message on a forward link in an M2M wireless WAN. In one embodiment, a condition of a forward link in the M2M wireless WAN may be determined. The condition of the forward link may be favorable to support high data rates. Conversely, the condition of the forward link may not be satisfactory to support high data rates. In one configuration, a data rate may be selected to transmit the ACK message. The data rate may be selected based on the condition of the forward link. In one embodiment, the ACK message may be a compressed identifier (ID) of the M2M device that is to receive the ACK message. The ID may be compressed by applying a hash function to a network ID of the M2M device. The compressed ID may be grouped together with a number of other compressed IDs into a single ACK packet. The number of compressed IDs within the ACK packet may vary depending on the condition of the forward link. If the condition is favorable, more compressed IDs may be inserted into the ACK packet than if the conditions are unfavorable.

In one embodiment, methods, systems, and devices are described for managing wireless communications in an M2M wireless WAN. An event is detected that indicates a condition of a forward link in the M2M wireless WAN. A data rate is selected to transmit an ACK message. The selection of the data rate is based at least in part on the detected event that indicates the condition of the forward link. The ACK message is transmitted on the forward link in the M2M wireless WAN according to the selected data rate.

In one configuration selecting the data rate to transmit the ACK message may include determining whether a number of copies of a packet received on a reverse link exceeds a threshold, and upon determining that the number of copies of the packet exceeds the threshold, inserting the ACK message into a first ACK packet, the first ACK packet including a first number of ACK messages. Selecting the data rate to transmit the ACK message may further include inserting the ACK message into a second ACK packet upon determining that the number of copies of the packet fails to exceed the threshold. The second ACK packet may include a second number of ACK messages. The second number of ACK messages may be greater than the first number of ACK messages. Each of the ACK messages in the first and second ACK packets may be addressed to a different M2M device in the M2M wireless WAN.

In one configuration, detecting an event may include identifying a number of copies of a packet received on a reverse link in the M2M wireless WAN. In one embodiment, the ACK message may be generated upon receiving at least one copy of the packet on the reverse link. Generating the ACK message may include applying a hash function to an identifier (ID) of an M2M device that sent the at least one copy of the packet on the reverse link to obtain a compressed ID of the M2M device. The compressed ID may include the ACK message. The hash function may be applied to a network ID of the M2M device.

In one embodiment, a time slot of a physical layer frame may be identified. The ACK message may be transmitted during the identified time slot. Transmitting the ACK message may include transmitting the ACK message during an ACK time slot of a forward link frame using an ACK channel. The ACK channel may include a common or shared channel.

A base station configured for wireless communication in an M2M wireless WAN is also described. The base station may include a processor and memory in electronic communication with the processor. Instructions may be stored in the memory. The instructions may be executable by the processor to detect an event that indicates a condition of a forward link in the M2M wireless WAN. The instructions may also be executable by the processor to select a data rate to transmit an ACK message. The selection of the data rate may be based at least in part on the detected event that indicates the condition of the forward link. The instructions may be further executable by the processor to transmit the ACK message on the forward link in the M2M wireless WAN according to the selected data rate.

An apparatus configured for wireless communication in an M2M wireless WAN is also described. The apparatus may include means for detecting an event that indicates a condition of a forward link in the M2M wireless WAN, and means for selecting a data rate to transmit an ACK message. The selection of the data rate may be based at least in part on the detected event that indicates the condition of the forward link. The apparatus may further include means for transmitting the ACK message on the forward link in the M2M wireless WAN according to the selected data rate.

A computer program product for managing wireless communication in an M2M wireless WAN is also described. The computer program product may include a non-transitory computer-readable medium storing instructions executable by a processor to detect an event that indicates a condition of a forward link in the M2M wireless WAN, and select a data rate to transmit an ACK message. The selection of the data rate may be based at least in part on the detected event that indicates the condition of the forward link. The instructions may be further executable by the processor to transmit the ACK message on the forward link in the M2M wireless WAN according to the selected data rate.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system;

FIG. 2 illustrates an example of a wireless communication system including a wireless wide area network (WAN) implementing M2M communications;

FIG. 3A shows a block diagram illustrating one embodiment of a paging system;

FIG. 3B is a block diagram illustrating one embodiment of a wireless communications system;

FIG. 4A is a block diagram illustrating a device for managing forward link communications in accordance with various embodiments;

FIG. 4B is a block diagram illustrating one embodiment of a forward link communications module;

FIG. 5A is a block diagram illustrating a device for managing reverse link communications in accordance with various embodiments;

FIG. 5B is a block diagram illustrating one embodiment of a reverse link communications module;

FIG. 6 is a block diagram illustrating a device for managing forward link communications in accordance with various embodiments;

FIG. 7 is a block diagram illustrating one embodiment of an acknowledgment generating module in accordance with the present systems and methods;

FIG. 8 illustrates one example of dynamically selecting a data rate to transmit ACKs on the forward link in accordance with the present systems and methods;

FIG. 9 shows a block diagram of a communications system that may be configured for creating and transmitting an ACK message to M2M devices in accordance with various embodiments;

FIG. 10 is a flow chart illustrating one example of a method for managing early termination of reverse link communications using ACK messages on forward link communications;

FIG. 11 is a flow chart illustrating one example of a method for managing early termination on the reverse link by selecting a data rate to transmit an ACK message based on a number of copies of a packet received on the reverse link; and

FIG. 12 is a flow chart illustrating one example of a method for managing reverse link communications by transmitting ACKs on the forward link at different data rates and on a random access channel.

### DETAILED DESCRIPTION

Methods, systems, and devices are described to generate and transmit an acknowledgment (ACK) message on a forward link at different data rates in a wireless M2M WAN. Traditional cellular systems may employ additional physical layer channels to facilitate communications between a base station and a terminal. For example, a traffic channel and an ACK channel may be set up between the terminal and the base station before communications occur. Setting up these channels, however, requires bandwidth and terminal power. In an M2M wireless WAN, conserving power of the M2M devices may be desirable. As a result, the traditional approach of cellular systems presents significant drawbacks for M2M wireless WANs.

If a dedicated channel is not set up as the ACK channel in the M2M wireless WAN, a base station may transmit a network ID of an M2M device as the ACK message. This may allow each M2M device to identify its corresponding ACK message transmitted on a common or shared ACK channel. Network IDs, however, include a large number of bits and also require bandwidth. Further, typical ACK messages are transmitted to each terminal at the lowest data rate possible. In an M2M wireless WAN, this may delay M2M devices with strong signal strength from terminating their transmission as early as possible because the ACK message is not timely received, which may be due to the ACK channel capacity being limited from the use of the lowest data rate for the ACK channel. As a result, M2M devices may continue to use power to continue their transmission to the base station. Thus, eliminating the need for setting up physical layer channels, formatting the ACK to contain a minimum number of bits, and transmitting the ACK at different data rates may enhance the early termination on the reverse link and further conserve power for M2M devices.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

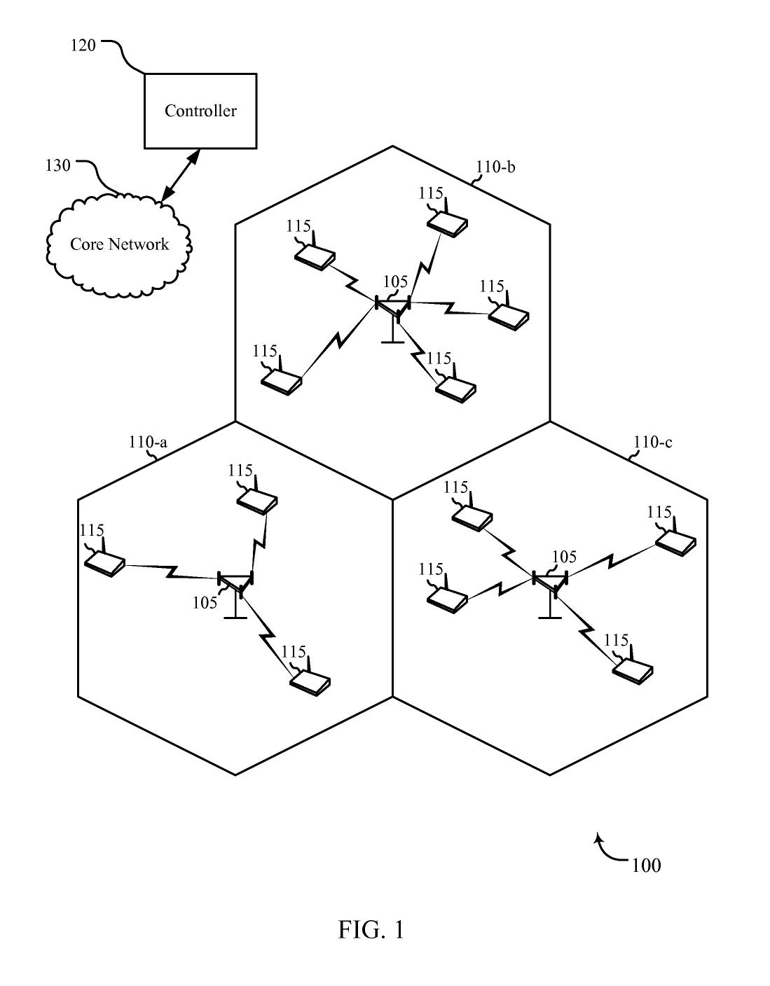

Referring first to FIG. 1, a block diagram illustrates an example of a wireless communications system 100. The system 100 includes base stations 105 (or cells), machine-to-machine (M2M) devices 115, a base station controller 120, and a core network 130 (the controller 120 may be integrated into the core network 130). The system 100 may support operation on multiple carriers (waveform signals of different frequencies).

The base stations 105 may wirelessly communicate with the M2M devices 115 via a base station antenna (not shown). The base stations 105 may communicate with the M2M devices 115 under the control of the base station controller 120 via multiple carriers. Each of the base station 105 sites may provide communication coverage for a respective geographic area. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, pico, and/or femto base stations). A macro base station may provide communication coverage for a relatively large geographic area (e.g., 35 km in radius). A pico base station may provide coverage for a relatively small geographic area (e.g., 10 km in radius), and a femto base station may provide communication coverage for a relatively smaller geographic area (e.g., 1 km in radium). There may be overlapping coverage areas for different technologies.

The M2M devices 115 may be dispersed throughout the coverage areas 110. Each M2M device 115 may be stationary or mobile. In one configuration, the M2M devices 115 may be able to communicate with different types of base stations such as, but not limited to, macro base stations, pico base stations, and femto base stations. The M2M devices 115 may be sensors and/or meters that monitor and/or track other devices, environmental conditions, etc. The information collected by the M2M devices 115 may be transmitted across a network that includes a base station 105 to a back-end system, such as a server. The transmission of data to/from the M2M devices 115 may be routed through the base stations 105. The base stations 105 may communicate with the M2M devices on a forward link. In one configuration, the base stations 105 may generate a forward link frame with a number of time slots that include channels to carry data and/or messages to an M2M device 115. In one example, each forward link frame may include no more than three time slots and one or more corresponding channels. These slots and channels may include a paging slot with a paging channel, an ACK slot with an ACK channel, and a traffic slot with a traffic channel. The length of an individual frame may be short (e.g., 20 milliseconds (ms)). In one embodiment, four frames may be joined to form a larger frame with a duration of 80 ms. Each frame included in the larger frame may include no more than three time slots and channels such as the paging slot for the paging channel, the ACK slot for the ACK channel, and the traffic slot for the traffic channel. The paging and ACK slots of each frame may each have a length of 5 ms while the traffic slot of each frame may have a length of 10 ms. An M2M device 115 may wake up during the individual frames (within the larger frame) that include data and/or messages on its channels that are intended for that M2M device 115.

In one configuration, an M2M device 115 may transmit one or more copies of a packet to a base station 105 on a reverse link. The base station 105 may transmit an ACK message on the forward link to notify the M2M device that the packet has been decoded by the base station 105. The M2M device 115 may continue to transmit copies of the packet until an ACK message is received, at which time the M2M device 115 may cease the transmission of copies of the packet.

In one embodiment, a channel may be used to transmit the ACK message to the M2M device 115. The channel may be a common or shared channel. As a result, the base station 105 may transmit multiple ACK messages for different M2M devices as an ACK packet on the common or shared ACK channel. The base station 105 may transmit an ACK packet with a greater number of individual ACK messages to M2M devices where conditions on the forward link are favorable. ACK packets with a lesser number of individual ACK messages may be transmitted to M2M devices where conditions on the forward link are not ideal. As a result, the data rate at which ACK messages are transmitted to M2M devices may vary depending on the condition of the forward link. Termination on the reverse link may occur earlier for M2M devices that receive their ACK message at a higher data rate.

In one embodiment, M2M devices 115 may be incorporated in other devices or the M2M devices 115 may be standalone devices. For example, devices such as cellular phones and wireless communications devices, personal digital assistants (PDAs), other handheld devices, netbooks, notebook computers, surveillance cameras, handled medical scanning devices, home appliances, etc. may include one or more M2M devices 115.

In one example, the network controller 120 may be coupled to a set of base stations and provide coordination and control for these base stations 105. The controller 120 may communicate with the base stations 105 via a backhaul (e.g., core network 125). The base stations 105 may also communicate with one another directly or indirectly and/or via wireless or wireline backhaul.

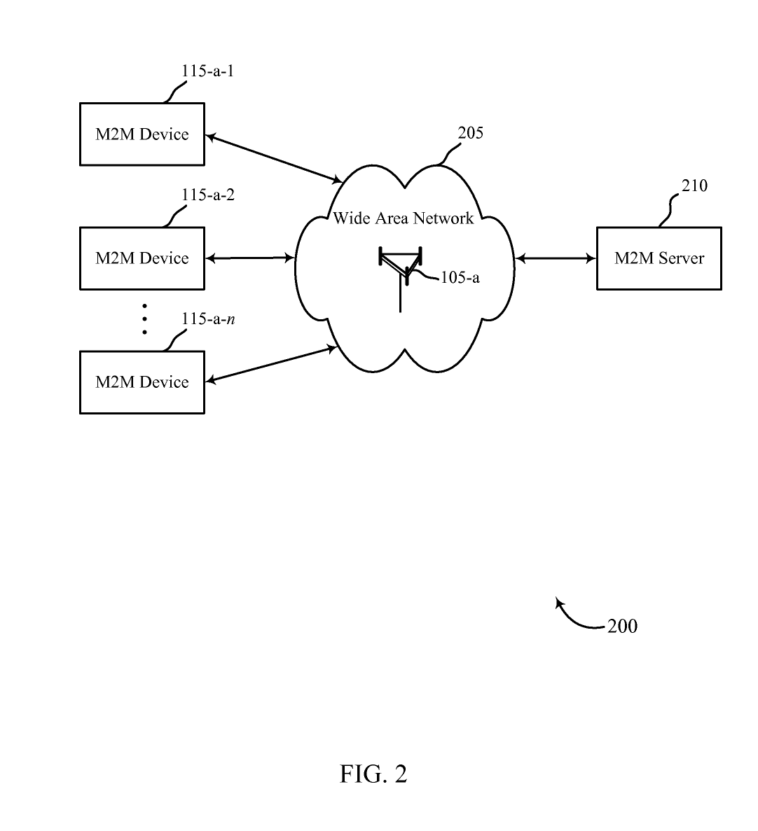

FIG. 2 illustrates an example of a wireless communication system 200 including a wireless wide area network (WAN) 205 implementing an M2M service according to one aspect. The system 200 may include a number of M2M devices 115-a and an M2M server 210. Communications between the server 210 and M2M devices 115 may be routed through a base station 105, that may be considered part of the WAN 205. The base station 105-a may be an example of the base stations illustrated in FIG. 1. The M2M devices 115-a may be examples of the M2M devices 115 illustrated in FIG. 1. One skilled in the art would understand that the quantity of M2M devices 115-a, WANs 205, and M2M servers 210 shown in FIG. 2 is for illustration purposes only and should not be construed as limiting.

The wireless communication system 200 may be operable to facilitate M2M communications. M2M communications may include communications between one or more devices without human intervention. In one example, M2M communications may include the automated exchange of data between a remote machine, such as an M2M device 115-a, and a back-end IT infrastructure, such as the M2M server 210, without user intervention. The transfer of data from an M2M device 115-a to the M2M server 210 via the WAN 205 (e.g., the base station 105-a) may be performed using reverse link communications. Data collected by the M2M devices 115-a (e.g., monitoring data, sensor data, meter data, etc.) may be transferred to the M2M server 210 on the reverse link communications.

The transfer of data from the M2M server 210 to an M2M device 115-a via the base station 105-a may be performed via forward link communications. The forward link may be used to send instructions, software updates, and/or messages to the M2M devices 115-a. The instructions may instruct the M2M devices 115-a to remotely monitor equipment, environmental conditions, etc. M2M communications may be used with various applications such as, but not limited to, remote monitoring, measurement and condition recording, fleet management and asset tracking, in-field data collection, distribution, and storage, etc. The base station 105-a may generate one or more forward link frames with a small number of time slots with channels to transmit instructions, software updates, and/or messages. The various M2M devices 115-a may wake up during the time slots of a specific frame when instructions or other data is included on a channel during the time slots of that frame. The devices 115-a may become aware that instructions or other data are available by decoding a paging message during a paging slot of a frame. A paging cycle may indicate how often the base station 105-a should transmit a paging message to an M2M device 115-a. The device 115-a may wake up during a paging slot to monitor for a paging message according to the paging cycle. The paging messages may be transmitted at different data rates, depending on the signal strength of the M2M device 115-a.

In one configuration, different types of M2M communications may be proposed in different wireless access networks that use different addressing formats. Different addressing formats may lead to different types of M2M devices 115-a being used for different services. In one aspect, an M2M network may be implemented which may maintain the M2M devices 115-a independent of the WAN technology that is used to communicate with the M2M server 210. In such an aspect, the M2M devices 115-a and the M2M server 210 may be made independent of the WAN technology that is used. As a result, a WAN technology used for backhaul communication may be replaced with a different WAN technology, without affecting the M2M devices 115-a that may already be installed. For example, the M2M server 210 and an M2M device 115-a may communicate with each other irrespective of the addressing format used by the WAN technology since the addressing format used by the M2M device 115-a may not be tied with the addressing used by the implemented WAN technology.

In one embodiment, the behavior of the M2M devices 115-a may be pre-defined. For example, the day, time, etc. to monitor another device and transmit the collected information may be pre-defined for an M2M device 115-a. For example, the M2M device 115-a-1 may be programmed to begin monitoring another device and collect information about that other device at a first pre-defined time period. The device 115-a-1 may also be programmed to transmit the collected information at a second pre-defined time period. The behavior of an M2M device 115-a may be remotely programmed to the device 115-a. Data rates and duty cycles used to transmit paging messages may be flexible depending on various conditions. Details regarding dynamically changing data rates used to transmit paging messages will be described below.

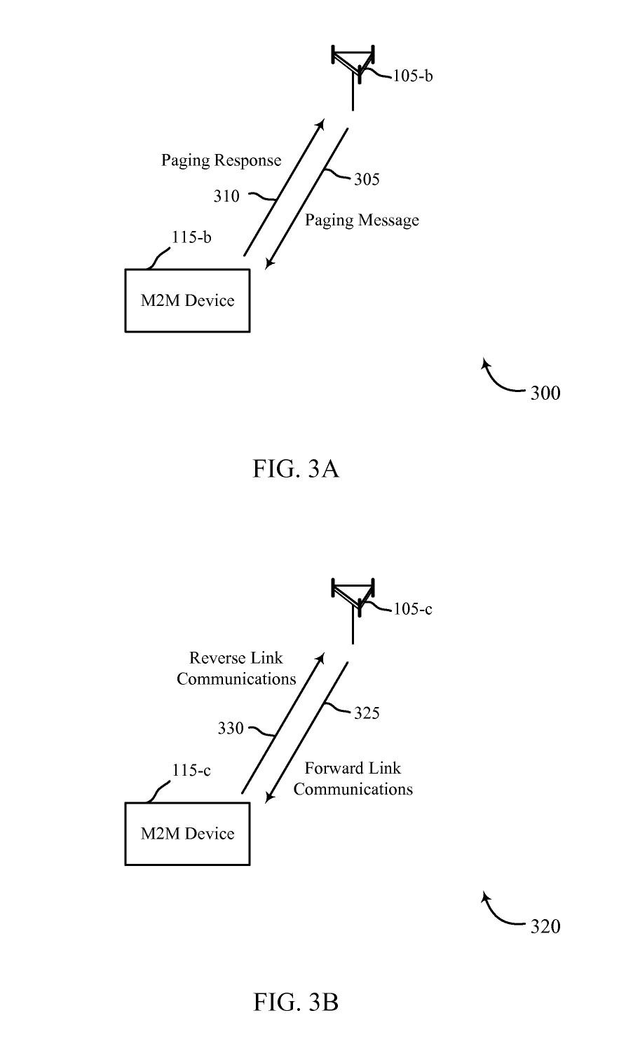

FIG. 3A is a block diagram illustrating one embodiment of a paging system 300 including a base station 105-b and an M2M device 115-b. The base station 105-b may be an example of the base stations 105 of FIG. 1 or 2. The M2M device 115-b may be an example of the M2M devices 115 of FIG. 1 or 2.

In a wireless communication system, such as the systems of FIG. 1 or 2, the notions of sleep state and paging are important to provide network connectivity to a large population of devices (e.g., M2M devices 115) in a battery power and air link resource efficient manner. A sleep state may provide the M2M device 115-b with a mode of operation to minimize battery power consumption by shutting down the whole or a part of the devices' transmit/receive circuitry. In addition, an M2M device 115 in the sleep state may not be allocated any dedicated air link resource and therefore a large number of M2M devices may be simultaneously supported. During time intervals where the M2M device 115-b has no traffic activity, the device 115-b may remain in the sleep state to conserve resources.

Paging may involve the M2M device 115-b waking up periodically from the sleep state, and having the M2M device 115-b operate to receive and process a paging message 305 in the forward link communications (e.g., communications from the base station 105-b to the M2M device 115-b). The base station 105-b may be aware when the M2M device 115-b should wake up. Thus, if the base station 105-b intends to contact, or page, the M2M device 115-b, the base station 105-b may send the paging message 305 in a paging channel during all or a portion of one or more paging slots of a forward link frame at the time when the M2M device 115-b is scheduled to wake up and monitor the paging channel. The base station 105-b, however, may not be aware of the signal strength of each M2M device 115 in the M2M wireless WAN. As a result, the base station 105-b may transmit paging messages at a high data rate using a first paging channel. If the M2M device 115-b is unable to properly demodulate the paging message 305 because the signal strength of the device 115-b is too low, the base station 105-b may dynamically change the data rate used to transmit the message to the device 115-b. In addition, the base station 105 may increase the frequency it transmits the paging message 305 and the device 115-b may increase the frequency it wakes up to monitor for the paging message 305 sent at the lower data rate. In one configuration, if the base station 105-b does not receive a paging response 310 confirming that the M2M device 115-b has received the paging message, the base station 105-b may retransmit the paging message 305 on a second paging channel during the paging slot more frequently and at a lower data rate. The base station 105-b may retransmit the paging message 305 until either the M2M device 115-b receives the paging message 305 and transmits a paging response 310 and/or a certain number of transmissions of the paging message 305 have occurred. If one or both of these events occur, the base station 105-b and the M2M device 115-b may return to operate under the previous paging cycle and the base station 105-b may return to transmit paging messages to the device 115-b at a high data rate using the first paging channel.

The time interval between two successive wake-up periods of an M2M device 115-b may be referred to as a paging cycle. The M2M device 115-b may operate in a sleep state during the portion of the paging cycle when the M2M device 115-b is not performing processing related to receiving a paging message 305. In order to maximize the benefit of the sleep state, the paging system 300 may use a large value for the paging cycle. For example, in a data system, the paging cycle may be about 5 minutes. As mentioned above, if the base station 105-b does not receive the paging response 310 indicating the successful receipt of the paging message 305, the base station 105-b may retransmit the paging message 305 using a smaller paging cycle until the paging response 310 is received. The retransmission of the paging message 305 may occur using the same channel or a different channel. Further, the M2M device 115-b may wake up more periodically (i.e., shorter paging cycle) to monitor paging slots of frames for the paging message 305.

In one embodiment, the paging channel used during the paging slot of a frame may have sufficient bandwidth to carry a number of paging messages 305. In one example, the paging channel may carry less than the maximum amount of paging messages 305. The base station 105-b may insert system information into the extra, unused bandwidth of the paging channel during the paging slot. The system information may be used by a number of M2M devices 115 to acquire the timing of the signals transmitted from the base station 105-b. Reusing the paging channel to transmit system information avoids the need to set up additional channels during additional time slots of the forward link frames to carry such information (which may increase the overall length of a forward link frame). As a result, M2M devices 115 may conserve power by minimizing the amount of time they are in an awake mode. By reusing the paging channel, the time slots of the frames transmitted on the forward link may be kept short, allowing the M2M devices 115 to return to the sleep mode as quickly as possible.

Upon receiving the paging message 305, the M2M device 115-b may carry out any operations specified in the paging message 305. For example, the M2M device 115-b may just receive the paging message 305 and go back to the sleep state. Alternatively, the M2M device 115-b may access the base station 105-b to establish an active connection with the base station 105-b.

FIG. 3B is a block diagram illustrating one embodiment of a wireless communications system 320. The system 320 may include a base station 105-c and an M2M device 115-c. The base station 105-c and the M2M device 115-c may be examples of the base stations and M2M devices of FIG. 1, 2, or 3A. In one configuration, the base station 105-c may communicate with the M2M device 115-c using a forward link frame with a limited number of time slots for logical channels used for forward link communications 325. The M2M device 115-c may communicate with the base station 105-c using reverse link communications 330. Communications that occur using the forward and reverse link communications may be M2M communications, as described above. These communications may take various forms, depending principally on the air interface protocol used by the base station 105-c and the M2M device 115-c.

The base station 105-c may be arranged to communicate on one or more carrier frequencies, typically using a pair of frequency bands to define the forward and reverse links communications, respectively. The base station 105-c may also include a set of directional antenna elements arranged to define multiple cell sectors. M2M communications in each sector on a given carrier frequency may be distinguished from communications in other sectors by modulating the communications in the given sector with a sector-specific code, such as a pseudo-random noise offset (“PN offset”). Further, M2M communications in each sector may be divided into control and traffic channels, each of which may be defined through time division multiplexing (TDM).

In one embodiment, signals may be transmitted on the forward link communications 325 and the reverse link communications 330 in a frame format. Within the frame format, information may be packetized and formatted according to the actual payload data to be communicated over the communication links 325, 330. In one configuration, the format of a frame transmitted on the forward link communications 325 may include various time slots for various channels. In one embodiment, the frame may include a paging slot for the paging channel, an ACK slot for the ACK channel, and a traffic slot for the traffic channel. As mentioned above, paging messages 305 and/or system information may be transmitted in the paging channel (according to the paging cycle) to the M2M device 115-c during a paging slot. ACK message may be transmitted in the ACK channel to an M2M device during the ACK time slot when a signal or data is successfully received at the base station 105-c. Traffic data may be transmitted in the traffic channel to the M2M device 115-c during the traffic time slot. Frames used on the forward link communications 325 in M2M communications may be based on a short duty cycle.

To conserver power, an M2M device 115 may wake up only during specific time slots of specific forward link frames to receive data, paging messages 305, etc. As a result, the frame structure in M2M communications may be slotted for each M2M device. Thus, each device 115 may only be required to wake up for the slot of the frame that is needed to retrieve its data. Paging messages may be transmitted at a first data rate according to a first paging cycle. If certain conditions change, the data rate and paging cycle may dynamically change. For example, the data rate may be lowered and the cycle may be shortened. As a result, the device 115 may wake up more frequently to monitor the paging slots for paging messages transmitted at a lower data rate. The data rate may be lowered and the paging cycle may be shortened if the device 115 is unable to successfully decode a paging message at the original data rate and paging cycle.

In one configuration, to preserve communication resources, the M2M device 115-c may perform opportunistic decoding of a message transmitted from the base station 105-c in order to return to the sleep state, according to the present systems and methods. In one embodiment, the base station 105-c may generate one or more forward link frames and transmit multiple copies of a message to the M2M device 115-c using a channel of the one or more forward link frames. Each copy of the message may be sent in a sub-channel at a high data rate. The M2M device 115-c may read as many copies of the message as are needed to successfully demodulate the message. In one configuration, the M2M device 115-c may estimate the number of copies of the message it needs to receive to decode the message based on the received signal strength from a pilot signal transmitted from the base station 105-c. Upon successfully decoding the message, the device 115-c may return to a sleep state before generating and transmitting an physical layer ACK message back to the base station 105-c. If additional copies of the message remain in the sub-channels, the base station 105-c may continue to transmit the additional copies (even though the M2M device 115-c has returned to the sleep state). In one configuration, the device 115-c may conserve battery power by not transmitting the physical layer ACK message to the base station indicating that the message has been received.

In one embodiment, the reverse link communications 330 may be terminated early to conserve the battery power of the M2M device 115-c and air interface resources between the M2M device 115-c and the base station 105-c. As stated above, a forward link frame may include an ACK slot during which an ACK message may be transmitted. The channel used to transmit the ACK message during the slot may be a common or shared channel. The base station 105-c may use channel to carry ACK messages that acknowledge the reception of a reverse link physical layer packet sent from the M2M device 115-c using the reverse link communications 330. In one configuration, a greater number of ACK messages may be transmitted in an ACK packet when the conditions of the forward link frame appear to be favorable. This may include identifying a number of copies of a packet an M2M device must transmit on the reverse link communication 330 until it is successfully decoded by the base station. Similarly, a smaller number of ACK messages may be transmitted in an ACK packet when the conditions of the forward link do not appear to be as favorable. Increasing and decreasing the number of ACK messages in a packet effectively changes the data rate that is used to transmit an ACK message to an M2M device. As a result, rather than sending every ACK message at the lowest data rate, some ACK messages may be sent at a higher data rate. When ACKs (i.e., ACK messages) are transmitted at higher data rates to the M2M device 115-c, the device 115-c may receive and decode the ACK more quickly, thus increasing the forward link ACK throughput and terminating the reverse link communications 330 at an earlier time period than if the ACK was transmitted using a low data rate.

In one configuration, the operating band of the reverse link communications 330 may be divided into multiple reverse link frequency channels. Within each frequency channel, CDMA techniques may be used to multiplex the reverse link communications for multiple M2M devices 115. In one example, each reverse link frequency channel may have its own rise over thermal (ROT) operation point. At least one frequency channel may be dedicated as a low data rate random access channel. Dividing the operating band of the reverse link communications 330 may provide a low ROT operation target (e.g., 1 decibel (dB) or less) for reverse link communications. A low ROT may reduce the link budget requirement for those devices in locations with large path loss.

In one example, to increase the power efficiency of the M2M device 115-c, a narrowband frequency-division multiple access (FDMA) technique may be used for the reverse link communications 330. This technique may include dividing the operating band of the reverse link communications 330 into a number of narrowband frequency channels. The base station 105-c may broadcast the status and assignment of each narrowband channel to each M2M device 115. The status may be “busy” or “idle”. In one embodiment, the M2M device 115-c may only transmit data if a narrowband frequency channel is assigned to the device 115-c. The early termination of the reverse link communications 330 (described above) may be incorporated into the narrowband FDMA technique to exploit the signal-to-interference noise ratio (SINR) distribution and to support multiple data rates in the reverse link communications 330.

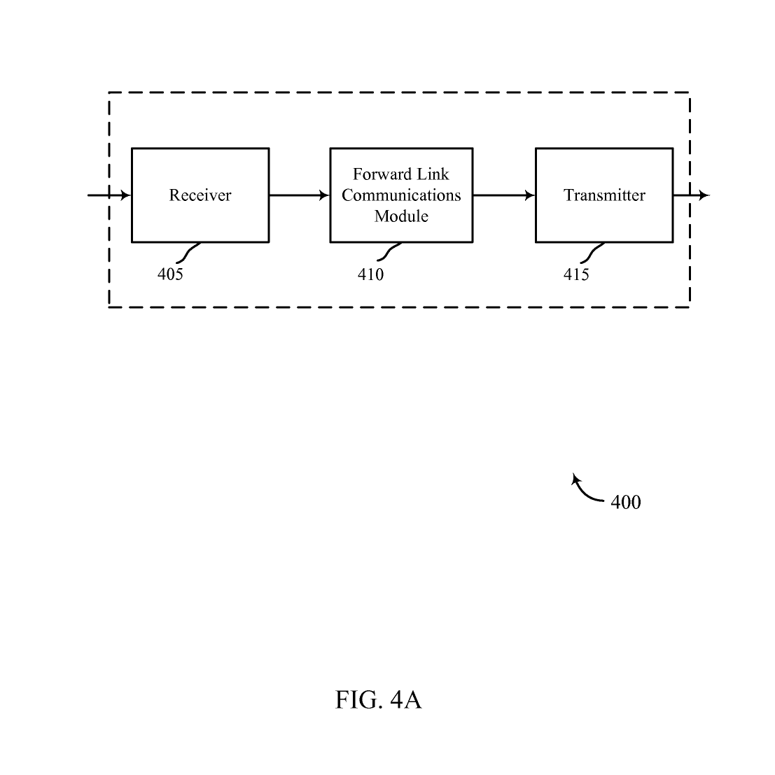

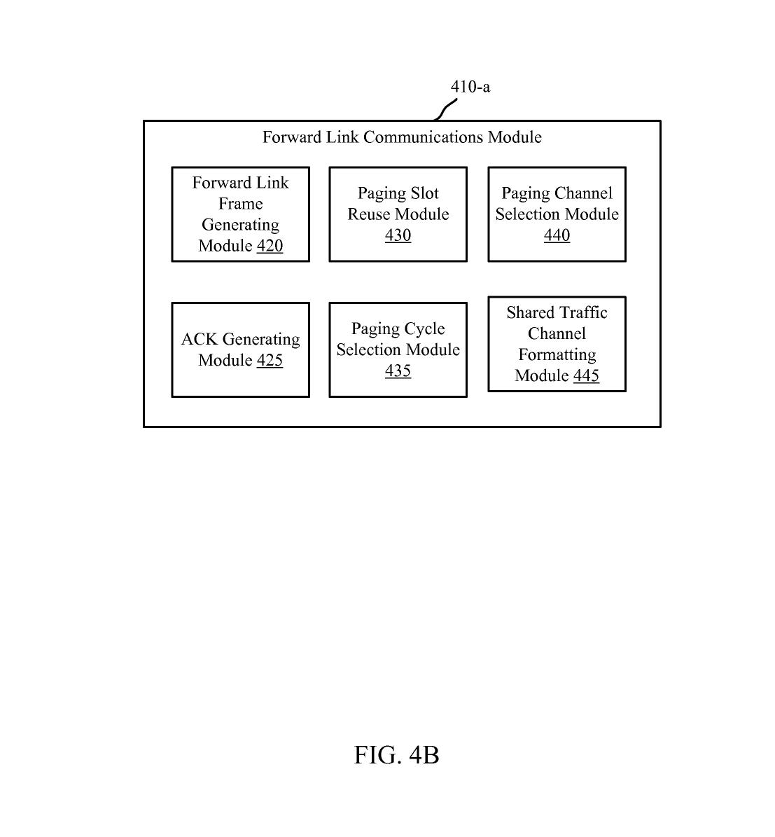

Turning next to FIG. 4A, a block diagram illustrates a device 400 for managing forward link communications in accordance with various embodiments. The device 400 may be an example of one or more aspects of base stations 105 described with reference to FIGS. 1, 2, 3A, and/or 3B. The device 400 may also be a processor. The device 400 may include a receiver module 405, a forward link communications module 410, and/or a transmitter module 415. Each of these components may be in communication with each other.

These components of the device 400 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405 may receive information such as packet, data, and/or signaling information regarding what the device 400 has received or transmitted. The received information may be utilized by the forward link communications module 410 for a variety of purposes.

The receiver module 405 may be configured to receive a reverse link physical layer packet sent from an M2M device 115 using reverse link communications 330. The receiver module 405 may also be configured to receive instructions, a set of operations, messages, etc. from a back-end server to communicate to an M2M device 115. The forward link communications module 410 may generate one or more forward link frames. The frames may be short duty cycle frames that include a minimal number of time slots used for logical channels. The forward link frames may be slotted for communications with multiple M2M devices. Details regarding the forward link frame will be described below.

The forward link communications module 410 may generate an ACK message indicating a packet has been successfully received and decoded on the reverse link 330. The transmitter module 415 may be configured to transmit the ACK message in the forward link frame to the M2M device 115. Instead of transmitting ACKs in a channel of the forward link frame at the lowest data rate, the ACKs may be transmitted at a higher data rate, resulting in early termination of communications received on the reverse link 330 by the receiver 405, as previously described.

In one embodiment, the forward link communications module 410 may generate a number of paging messages 305 to transmit to a number of M2M devices 115 via the transmitter module 415. The paging messages 305 may alert specific M2M devices 115 that a base station 105 is requesting the M2M device 115 to make contact with the base station 105. In one configuration, paging messages 305 may be transmitted in the paging channel (or a sub-channel of the paging channel) during the paging time slot at different data rates, depending on whether the M2M device 115 successfully demodulates a paging message.

In one configuration, the paging channel may include less than the maximum number of paging messages 305. If the paging channel does not include the maximum number of paging messages 305, the paging slot may be determined to idle. The unused capacity of the paging channel may be utilized by inserting system information into the paging channel. The system information may then be broadcast to the M2M devices 115 in the paging channel during the paging time slot of the forward link frame. Additional channels and time slots are avoided in forward link frames to transmit this type of information. Instead, idle paging time slots may be reused to transmit system information.

The receiver module 405 may receive a paging response 310 when the M2M device 115 successfully decodes the paging message 305. When the receiver module 405 does not receive the paging response 310, the forward link communications module 410 may be configured to instruct the transmitter module 415 to retransmit the paging message 305. The transmitter module 415 may retransmit the message 305 at a lower data rate and at a higher frequency than the original transmission of the paging message 305. The transmitter module 415 may cease the retransmission when a paging response 310 is received by the receiver module 405 and/or after a certain number of retransmissions of the message 305 have been transmitted. The transmitter module 415 may transmit and retransmit the paging messages 305 on different sub-paging channels of different forward link frames. In one configuration, when the paging channel is not needed to transmit a paging message 305, the forward link communications module 410 may generate and insert system information into the paging channel of the forward link frame. The transmitter module 415 may transmit the system information to an M2M device 115 in the paging channel of the frame. In one configuration, the transmitter 415 may transmit information using multiple paging channels of multiple frames. Paging messages may be transmitted in different paging channels at different data rates and at different paging cycles.

FIG. 4B is a block diagram illustrating one embodiment of a forward link communications module 410-a. The module 410-a may be an example of the forward link communications module of FIG. 4A. In one example, the module 410-a may include a forward link frame generating module 420, an ACK generating module 425, a paging slot reuse module 430, a paging cycle selection module 435, a paging channel selection module 440, and a shared traffic channel formatting module 445.

The forward link frame generating module 420 may generate a physical layer frame to be used for communications on the forward link 325 (e.g., from a base station to an M2M device). The generated frame may be based on a short duty cycle and a small number of slotted physical layer channels. For example, the module 420 may generate a forward link physical layer frame that is a total of 20 milliseconds (ms). The slotted operation of the frame generated by the module 420 may allow the M2M device 115 to wake up and turn on its radio only during the scheduled time slot of the frame where it is expecting data. As a result, the M2M device 115 may be in the awake mode for less than the length of the frame.

Each of the physical channels of the forward link frame may include both pilot symbols and data symbols, which may be time division multiplexed (TDM). In one configuration, a forward link frame generated by the module 420 may include a paging slot, an ACK slot, and a traffic slot. Paging messages and other information may be transmitted in a paging channel to an M2M device 115 on the forward link communications 325 during the paging time slot. ACK messages and additional information may be transmitted in an ACK channel (e.g., a random access channel) during the ACK slot. Data messages may be transmitted in a traffic channel to an M2M device 115 during the traffic slot.

The ACK generating module 425 may generate an ACK message to transmit on the forward link communications 325. The message may be transmitted in an ACK channel that is part of the forward link frame generated by the forward link frame generating module 420. In one configuration, the channel may be used to transmit a multiple ACKs in an ACK packet. Each ACK in the packet may be an identifier (ID) of an M2M device 115. The ID may be a network ID of an M2M device. In addition, the ID may be a compressed version of the network ID. For example, a compressed ID may be a hash of the network ID of the M2M device 115. In one configuration, the ACK generating module 425 may group the multiple ACKs to create the ACK packet. In one embodiment, ACK packets may include different quantities of ACKs depending on the channel conditions of the forward link.

In some instances, a paging slot may be idle for a certain forward link frame. For example, the capacity of the paging channel during the paging slot may not be at full capacity. For instance, the paging slot may not be scheduled to transmit a paging message 305 for an M2M device 115. As a result, the paging channel may be empty (e.g., no paging messages 305). The paging slot reuse module 430 may reuse the idle paging slot to communicate system information to the M2M device 115. The system information may include system timing and sector number information and may be inserted into the paging channel for transmission to the M2M devices 115 during the paging time slot. Thus, the establishment of additional channels within the forward link frame to convey the system information to an M2M device 115 may be avoided. Instead, the paging slot reuse module 430 may insert the system information in an idle paging channel of the paging slot in the frame.

In one embodiment, the paging cycle selection module 435 may select a particular paging cycle to transmit paging messages to an M2M device. The module 435 may provide a flexible paging scheme to dynamically change the paging cycle for an M2M device 115 in an M2M wireless WAN. The paging cycle selection module 435 may dynamically change the paging cycle depending on whether a paging response 310 is received from the device 115, the time of day, the state of operation of the M2M device 115, etc.

In one configuration, the paging channel selection module 440 may select between sub-channels of the paging channel to transmit a paging message to an M2M device 115 using the forward link communications 325. For example, the selection module 440 may select between a primary and secondary paging channel. The module 440 may provide a paging scheme that allows for paging messages to be transmitted at different data rates in an M2M WAN using primary and secondary paging channels. The primary paging channel may be used for longer paging cycles while the secondary paging channel may be used for shorter paging cycles. In one example, a base station 105 may transmit a first paging message. The module 440 may select the primary channel. The first paging message may be transmitted in the primary channel at a high data rate over a long paging cycle. The base station may also transmit a second paging message. The module 440 may select the secondary paging channel. The second paging message may be transmitted in the second paging message since the second message is to be transmitted at a lower data rate over a shorter paging cycle. In one embodiment, the first and second paging messages may be the same. In one example, the paging channels may be logical channels. In one configuration, the paging channels may be code division multiple access (CDMA) channels. In one example, the paging channels may be time division multiple access (TDMA) channels.

The shared traffic channel formatting module 445 may format a traffic channel in the forward link frame that may be shared by multiple M2M devices. When a M2M device 115 is expecting data on a shared traffic channel within a given traffic channel cycle, the device 115 may continue reading the traffic channel slots across multiple forward link frames during a traffic channel cycle until it finds its data as indicated by the ID field. As a result, the M2M device 115 may stay awake longer than necessary to find its data. The formatting module 445 may format the traffic channel in such a way so as to minimize the wake up time for the M2M device 115. The M2M device 115 may determine which slot of a particular frame to wake up in order to get its data on the shared traffic channel. To determine which slot to wake up for, the M2M device may use a set of hashing function on its ID. The M2M device may also use the number of slots at the expected data rate and the total number of users at that rate to determine the slot where it can expect to receive its data. The traffic channel may be formatted by the module 445 to allow the device to determine which slot to use. For example, the module 445 may format the shared traffic channel so that the hashed slot either contains the data or a pointer to a slot where the actual data is located. If a slot of a first frame cannot contain all the pointers, the module 445 may set an overflow flag and provide a pointer to another slot of another frame where the hashed M2M device can check for its data. If all the data for the M2M device 115 cannot be accommodated during a single slot, then the module 445 may format a trailer field of the channel to include a pointer to another slot where the remaining data is transmitted.

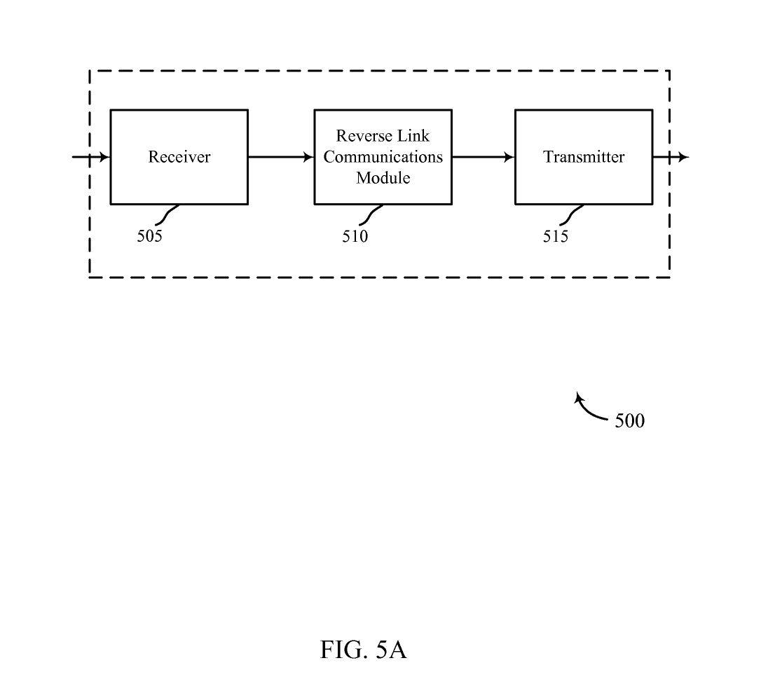

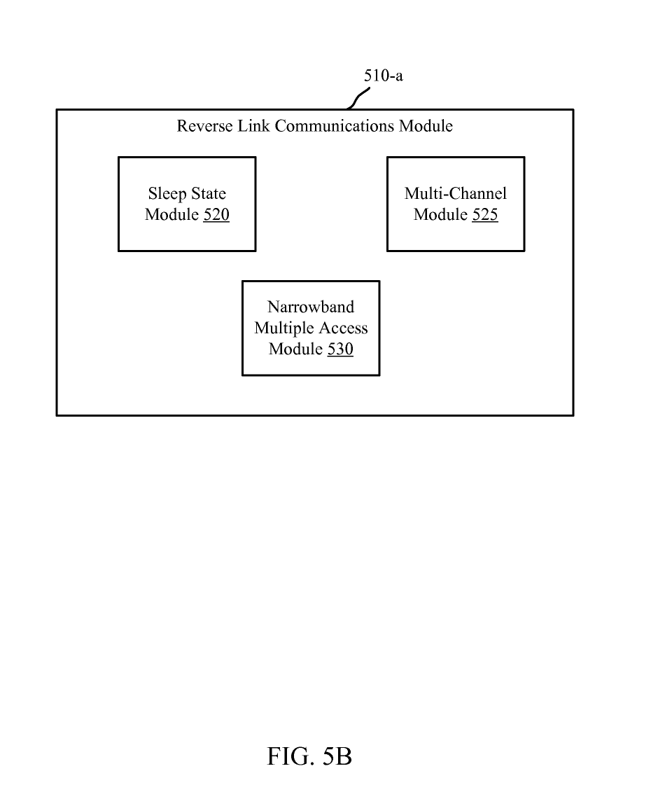

FIG. 5A is a block diagram illustrating a device 500 for managing reverse link communications in accordance with various embodiments. The device 500 may be an example of one or more aspects of the M2M device 115 and/or the base station 105 described with reference to FIGS. 1, 2, 3A, and/or 3B. The device 500 may also be a processor. The device 500 may include a receiver module 505, a reverse link communications module 510, and/or a transmitter module 515. Each of these components may be in communication with each other.

These components of the device 500 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive information such as packet, data, and/or signaling information regarding what the device 500 has received or transmitted. The received information may be utilized by the reverse link communications module 510 for a variety of purposes.

The receiver module 505 may be configured to receive a forward link physical layer packet sent from a base station 105 using forward link communications 325. The reverse link communications module 510 may generate a reverse link frame that includes a traffic slot during which traffic may be transmitted from an M2M device 115 to a base station 105.

In one embodiment, the reverse link communications module 510 may cause communications on the reverse link to terminate early. As previously explained, the forward link frame may include an ACK channel to carry ACK messages from the base station 105 to an M2M device 115 at a high data rate. Upon receiving the ACK message, the reverse link communications module 510 may instruct the transmitter 515 to cease transmitting communications on the reverse link communications 330. Details regarding the reverse link communication module 510 will be described below.

FIG. 5B is a block diagram illustrating one embodiment of a reverse link communications module 510-a. The module 510-a may be an example of the reverse link communications module of FIG. 5A. In one example, the module 510-a may include a sleep state module 520, a multi-channel module 525, and a narrowband multiple access module 530.

In one configuration, the sleep state module 520 may allow an M2M device 115 to wake up long enough to receive a message from a base station 105 and then return to a sleep state to conserve power. The base station may transmit a message to the M2M device using a forward link frame. The frame may include a paging channel to carry the message. The paging channel may include a number of sub-channels. The base station may transmit a copy of the message in each sub-channel. When the M2M device successfully receives and demodulates the message on one of the sub-channels, the sleep state module 520 may cause the M2M device 115 to turn off its radio and return to a sleep state to conserve the battery without sending an ACK message back to the base station.

In one embodiment, the multi-channel module 525 may provide a code division multiple access (CDMA) based multiple access scheme to reduce negative effects of an operating rise over thermal (ROT) noise on the reverse link communications 330. In one configuration, the module 525 may divide the operating band of the reverse link into multiple reverse link frequency channels. Within each frequency channel, the module 525 may use CDMA for multiple user multiplexing. Each frequency channel may have its own target ROT operation point. The multi-channel module 525 may dedicate at least one frequency channel as a low data rate random access channel. As a result, the operating ROT may be reduced.

In one example, the narrowband multiple access module 530 may provide a narrowband frequency division multiple access (FDMA) technique for the reverse link communications 330. The module 530 may divide the operating band into a number of narrowband frequency channels. A busy or idle status of each narrowband channel may be broadcasted to each M2M device 115. The devices may contend for a channel selected randomly from the idle set of channels by sending a preamble. The module 530 may allow the M2M device 115 to transmit data only if a channel is either implicitly or explicitly assigned to the M2M device. The module 530 may not allow the transmission to be interrupted if the channel state changes to busy.

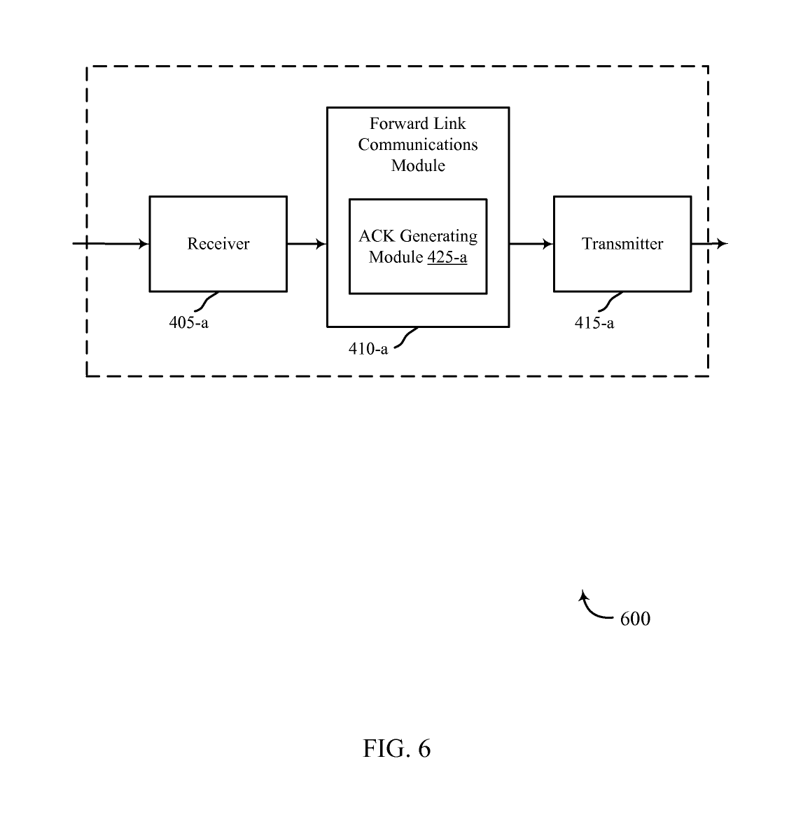

FIG. 6 is a block diagram illustrating a device 600 for managing forward link communications in accordance with various embodiments. The device 600 may be an example of one or more aspects of the base station described with reference to FIGS. 1, 2, 3A, 3B, 4A, and/or 4B. The device 600 may also be a processor. The device 600 may include a receiver module 405-a, a forward link communications module 410-a, and/or a transmitter module 415-a. Each of these components may be in communication with each other.

The components of the device 600 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 405-a may receive information such as packet, data, and/or signaling information regarding what the device 600 has received or transmitted. The received information may be utilized by the forward link communications module 410-a for a variety of purposes, as previously described.

In one configuration, the forward link communications module 410-a may include an ACK generating module 425-a. The module 425-a may create ACKs by using compressed IDs of M2M devices and group the ACKs into different ACK packets. The ACK packets may be inserted in a common or shared ACK channel for transmission to M2M devices. Details regarding the creation and transmission of ACKs will be described below.

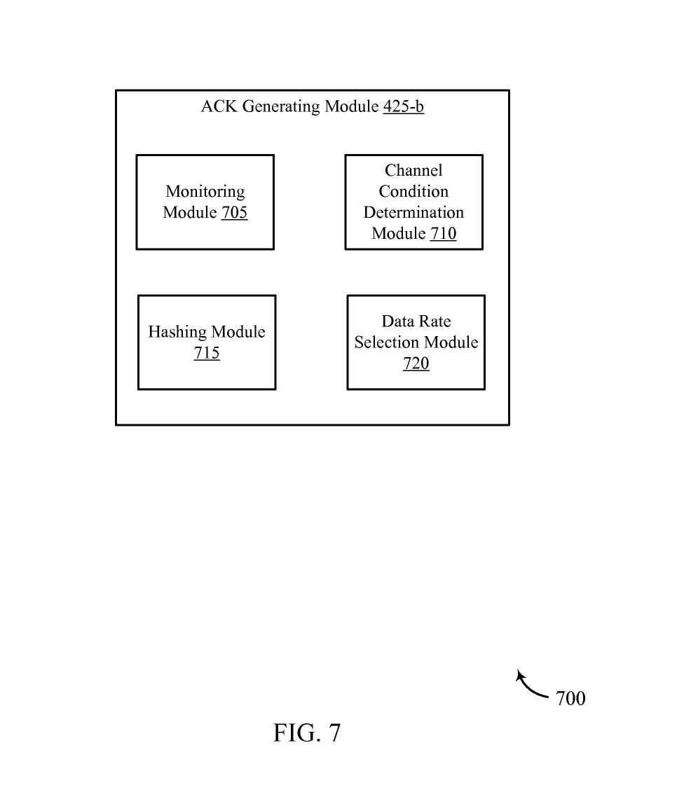

FIG. 7 is a block diagram illustrating one embodiment of an ACK generating module 425-b. The module 425-b may be an example of the ACK generating module 425 of FIGS. 4B and/or 6. In one configuration, the module 425-b may include a monitoring module 705, a channel condition determination module 710, a hashing module 715, and a data rate selection module 720.

In one example, the monitoring module 705 may monitor for events that may indicate a condition of forward link communications 325. In one example, the monitoring module 705 may monitor for a number of copies of a packet transmitted from an M2M device on reverse link communications 330. The module 705 may also monitor for pilot signals or other signals that reveal the condition of the reverse link communications 330, which would also indicate the condition of the forward link 325.

The channel condition determination module 710 may determine the condition of the forward link 325 based on the event monitored by the monitoring module 705. In one configuration, the monitoring module 705 may detect a certain number of copies of a packet were received. The condition determination module 710 may determine the condition of the forward link 325 may be favorable if the number of copies of the packet was less than a certain threshold. On the other hand, if a high number of copies of the packet were received, this may reveal weak communications between the base station 105 and an M2M device 115 on the reverse link 330. As a result, the module 710 may determine that the channel conditions on the forward link 325 are not ideal.

In one configuration, the hashing module 715 may apply a hashing function to an ID of an M2M device 115 that transmitted the packet to the base station 105. The hashed ID may be transmitted to the M2M device 115 on the forward link 325 to represent an ACK. In one embodiment, the ID may be the network ID of the M2M device 115. The network ID may be 32-bits. The hashing module 715 may apply the hashing function to create a compressed ID from the network ID. In one example, the compressed ID includes less bits than the network ID. Compressed IDs (i.e., ACKs) for a plurality of M2M devices may be grouped together into a single ACK packet. The ACK packet may be transmitted during an ACK slot of a forward link frame in an ACK channel. The ACK channel may be a common or shared channel.

The data rate selection module 720 may select a data rate to transmit ACKs to M2M devices 115 on the forward link. In one configuration, the module 720 may select the data rate by selecting the number of different ACKs to include in an ACK packet. For example, the hashing module 715 may hash a number of network IDs of various M2M devices 115 to create compressed IDs that serve as ACKs. If the channel condition determination module 710 determines that events monitored by the monitoring module 705 indicate favorable conditions on the forward link, the data rate selection module 720 may insert a higher number of ACKs into the ACK packet. If, however, the channel condition determination module 710 determines that the conditions of the forward link are not favorable, a smaller number of ACKs may be inserted in the ACK packet. As previously stated, a common or shared channel may be used to transmit the ACK packet during the ACK slot of a forward link frame. The length of the ACK slot may be 5 ms. Thus, as more or less ACKs are included in the ACK packet to be transmitted during 5 ms, the effective data rate of the ACK packet will either increase or decrease. As a result, ACKs may be transmitted at either a high or low data rate. M2M devices 115 that are capable of receiving at a high data rate may receive their corresponding ACK quicker and may terminate their transmission at an earlier time than if the ACKs were all transmitted at the lower data rate.

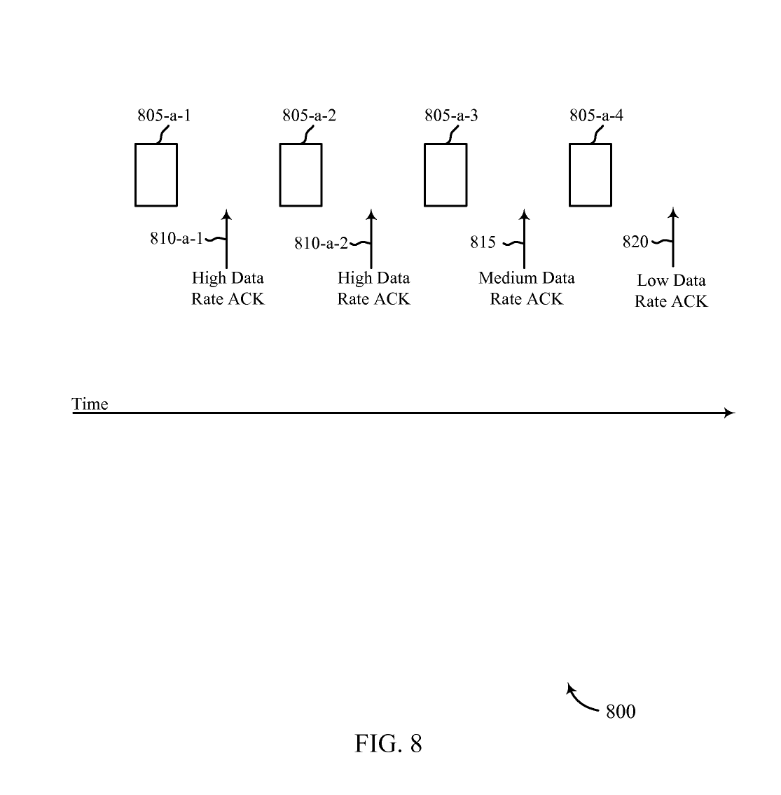

FIG. 8 illustrates one example 800 of dynamically selecting a data rate to transmit ACKs on the forward link in accordance with the present systems and methods. In one embodiment, an M2M device 115 may transmit a first copy of a packet 805-a-1 to a base station 105 on the reverse link 330. If the base station 105 is able to successfully decode the packet, the base station 105 may transmit an ACK to the M2M device 115 to notify the device 115 that the packet was successfully received and decoded. As described above, the ACK may be transmitted in a common channel which is not dedicated to any specific M2M device in an M2M wireless WAN. As a result, the ACK may include information to enable an M2M device 115 to identify its ACK from ACKs transmitted in the channel that are intended for other M2M devices. In one example, the ACK for an particular M2M device 115 may be a compressed version of the network ID of the device. Thus, multiple compressed IDs of different M2M devices may be transmitted on the common channel and each of the different M2M devices may apply a hash function to the different compressed IDs to identify their specific ACK.

In one embodiment, if the base station 105 is able to decode the packet after just a first copy of the packet 805-a-1 has been transmitted on the reverse link 330, this may indicate favorable conditions on the reverse link as well as the forward link. As a result, the base station 105 may attempt to transmit the ACK to the M2M device that transmitted the first copy 805-a-1 of the packet at a high data rate. To transmit the ACK (i.e., the compressed ID of the M2M device) at a high data rate, the base station 105 may group the ACK with a number of other ACKs intended for other M2M devices into a single ACK packet. As more ACKs are included in the packet, the higher the effective data rate will be for transmission of that packet during an ACK slot (e.g., during 5 ms).

In one example, after the first copy 805-a-1 of the packet is transmitted, a high data rate ACK 810-a-1 may be transmitted back to the M2M device. However, if the base station 105 is unable to decode the packet after receiving just one copy, no ACK will be transmitted to the M2M device 115. When the mobile device 115 does not receive an ACK during an ACK slot of a forward link frame after transmitting the first copy 805-a-1, the device 115 may transmit a second copy 805-a-2 of the packet. If the base station 105 is able to decode the packet using the second copy 805-a-2 and the first copy 805-a-1, an ACK 810-a-2 may be transmitted. In one example, the ACK may still be transmitted at a high data rate (e.g., an ACK packet with a higher number of other ACKs). If the base station 105 is unable to decode the packet after receiving the second copy 805-a-2, a third copy 805-a-3 of the packet may be transmitted. An ACK 815 may be transmitted at a medium data rate if the base station 105 decodes the packet after receiving the third copy 805-a-3. The medium data rate may be a rate that is lower than the high data rate that would have been selected had the base station 105 been able to decode and demodulate the packet after receiving the first or second copy.

As illustrated, if the M2M device 115 transmits a fourth copy 805-a-4 of the packet because it has not received an ACK after transmitting the first, second, or third copies, the base station 105 may transmit a low data rate ACK 815 if the base station is able to decode the packet after receiving the fourth copy 805-a-4. The ACK 815 may be transmitted at a lower data rate by inserting the ACK 815 into an ACK packet that includes a smaller number of other ACKs to transmit. If more than four copies of the packet are needed before the base station is able to decode the packet, the resulting ACK may be transmitted at a lower data rate. Thus, the base station 105 may become aware of the condition of the forward link by monitoring the number of copies of a packet sent from an M2M device 115 on the reverse link before the base station 105 is able to decode the packet. If channel conditions of the forward link are strong, the base station 105 may be able to decode the packet with just the first copy 805-a-1. The ACK 810-a-1 may be transmitted at a high data rate and the M2M device 115 may perform early termination on the reverse link since the packet has already been received by the base station 105.

While FIG. 8 illustrates a high data rate ACK being transmitted until three copies of a packet, it is to be understood that the high data rate ACK may be transmitted after more or less than three copies of a packet. Moreover, while there are three different data rates in this example, there may be more or fewer in other embodiments.

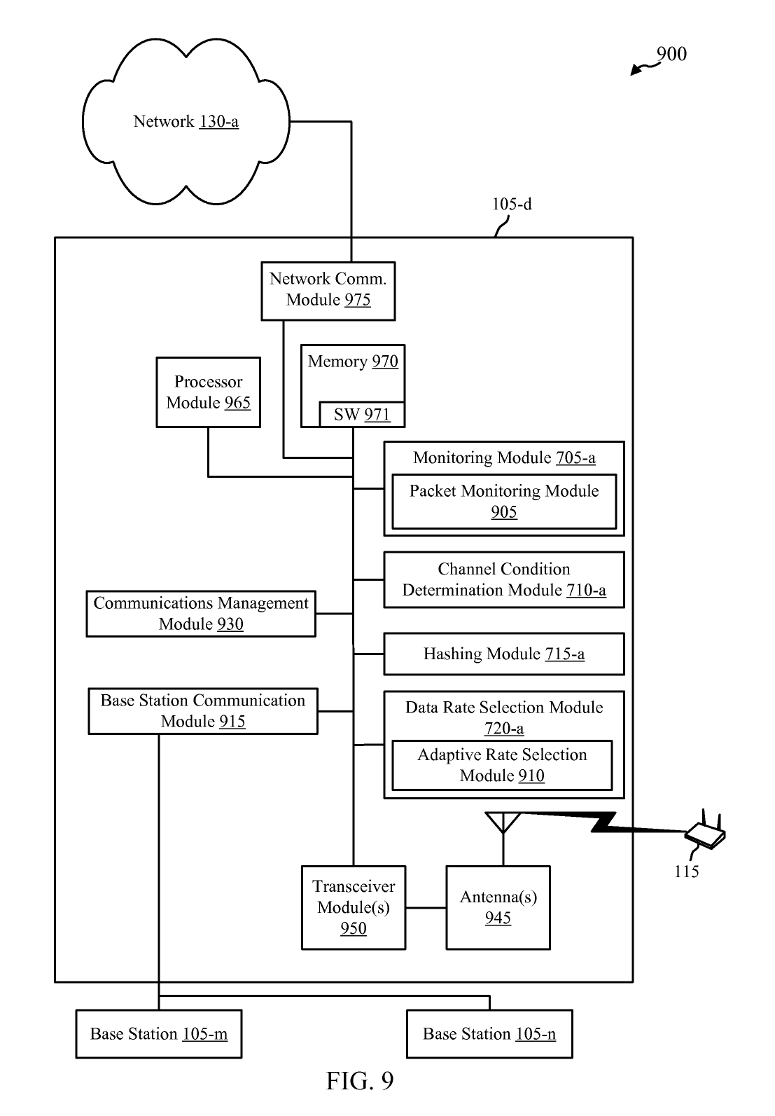

FIG. 9 shows a block diagram of a communications system 900 that may be configured for creating and transmitting an ACK at different data rates to M2M devices 115 in accordance with various embodiments. This system 900 may be an example of aspects of the system 100 depicted in FIG. 1, system 200 of FIG. 2, system 300 of FIG. 3A, 320 of FIG. 3B, system 400 of FIG. 4A, and/or system 600 of FIG. 6.

The system 900 may include a base station 105-d. The base station 105-d may include antennas 945, a transceiver module 950, memory 970, and a processor module 965, which each may be in communication, directly or indirectly, with each other (e.g., over one or more buses). The transceiver module 950 may be configured to communicate bi-directionally, via the antennas 945, with an M2M device 115, which may be a sensor, meter, or any other type of device capable of tracking, sensing, monitoring, etc. The transceiver module 950 (and/or other components of the base station 105-d) may also be configured to communicate bi-directionally with one or more networks. In some cases, the base station 105-d may communicate with the core network 130-a through network communications module 975.

Base station 105-d may also communicate with other base stations 105, such as base station 105-m and base station 105-n. Each of the base stations 105 may communicate with the M2M device 115 using different wireless communications technologies, such as different Radio Access Technologies. In some cases, base station 105-d may communicate with other base stations such as 105-m and/or 105-n utilizing base station communication module 915. In some embodiments, base station 105-d may communicate with other base stations through the controller 120 and/or core network 130-a.

The memory 970 may include random access memory (RAM) and read-only memory (ROM). The memory 970 may also store computer-readable, computer-executable software code 971 containing instructions that are configured to, when executed, cause the processor module 965 to perform various functions described herein (e.g., ACK schemes, dynamic data rate schemes for paging messages, flexible paging schemes, data traffic schemes, etc.). Alternatively, the software 971 may not be directly executable by the processor module 965 but may be configured to cause the computer, e.g., when compiled and executed, to perform functions described herein.

The processor module 965 may include an intelligent hardware device, e.g., a central processing unit (CPU) such as those made by Intel® Corporation or AMD®, a microcontroller, an application-specific integrated circuit (ASIC), etc. The transceiver module 950 may include a modem configured to modulate packets for the M2M device 115 and provide the modulated packets to the antennas 945 for transmission, and to demodulate packets received from the antennas 945. While some examples of the base station 105-d may include a single antenna 945, the base station 105-d preferably includes multiple antennas 945 for multiple links which may support carrier aggregation. For example, one or more links may be used to support macro communications with the M2M device 115.

According to the architecture of FIG. 9, the base station 105-d may further include a communications management module 930. The communications management module 930 may manage communications with other base stations 105. By way of example, the communications management module 930 may be a component of the base station 105-d in communication with some or all of the other components of the base station 105-d via a bus. Alternatively, functionality of the communications management module 930 may be implemented as a component of the transceiver module 950, as a computer program product, and/or as one or more controller elements of the processor module 965.

The components for base station 105-d may be configured to implement aspects discussed above with respect to device 700 in FIG. 7 and may not be repeated here for the sake of brevity. For example, the base station 105-d may include a monitoring module 705-a, a channel condition determination module 710-a, a hashing module 715-a, and a data rate selection module 720-a. These modules may be examples of the modules previously described with respect to FIG. 7. In one embodiment, the modules 705-a, 710-a, 715-a, and 720-a may be standalone modules or may be incorporated within the ACK generating module 425 described in FIGS. 4B, 6, and 7. In addition, some of the modules may be standalone while other may be incorporated as part of the ACK generating module 425.

In one configuration, the monitoring module 705-a may include a packet monitoring module 905. The module 905 may identify a number of copies of a packet transmitted from an M2M device 115 on the reverse link 330 to a base station 105. The channel condition determination module 710-a may determine the condition of the forward link 325 based on the number of copies of the packet identified by the module 905. If a high number of copies are transmitted, the channel module 710-a may determine that the conditions on the forward link 325 are not ideal. If, however, a low number of copies are transmitted, the module 710-a may determine that favorable conditions exist on the forward link 325.

In one embodiment, the data rate selection module 720-a may include an adaptive rate selection module 910. The module 910 may dynamically select the data rate to transmit ACK messages on the forward link. The data rate may be dynamically selected by changing the number of ACK messages placed in an ACK packet that is transmitted on the forward link. As the number of ACK messages in an ACK packet increases, the effective data rate of ACK packet is higher. The factors used to determine the number of ACK messages to include in an ACK packet may be adaptive and dynamic. In one example, an ACK message intended for an M2M device 115 may be placed in an ACK packet with a greater number of other ACK messages if the base station 105-d is able to decode data received from the device 115 after receiving a number of copies of the packet that is below a threshold. If the base station 105-d decodes the data after receiving a number of copies of the data packet that is above the threshold, the ACK message for that device 115 may be placed in an ACK packet with a lesser number of other ACK messages.

In one configuration, the adaptive rate selection module 910 may dynamically change the threshold used to determine the data rate at which ACK message are transmitted. For example, the threshold may be altered based on the amount of traffic on the forward and reverse links, the number of M2M devices 115 located in a particular cell, the number of M2M devices 115 in communication with the base station 105-d, the types of M2M devices 115 communicating across the M2M wireless WAN, etc. The adaptive rate selection module 910 may also adaptively modify the data rates at which ACK messages are transmitted. In one example, the module 910 may select multiple thresholds which indicate whether ACK messages should be transmitted at high data rates, low data rates, or somewhere between depending on whether the multiple thresholds are satisfied. For example, the module 910 may set multiple thresholds in which M2M devices that transmit 1-3 copies of a packet before the base station 105-d is able to decode the packet may receive their ACK messages at a high data rate while M2M devices that transmit 7-10 copies of a packet may receive their ACK messages at a low data rate. M2M devices that transmit 4-6 copies of a packet may receive their ACK message at a data rate that is somewhere between the high data rate and low data rate.

In some embodiments, the transceiver module 950 in conjunction with antennas 945, along with other possible components of base station 105-d, may transmit a number of forward link frames that each include an ACK slot, from the base station 105-d to the M2M device 115, to other base stations 105-m/105-n, or core network 130-a. ACKs may be transmitted during the ACK slot using a common or shared channel. The number of ACKs transmitted in the channel may be based in part on the determined channel conditions of the forward link as determined by the module 710-a.

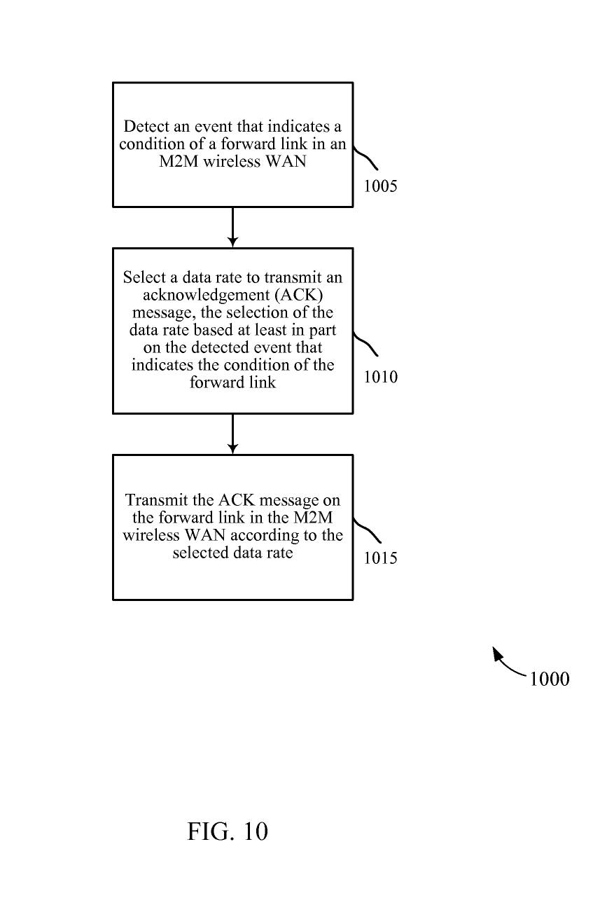

FIG. 10 is a flow chart illustrating one example of a method 1000 for managing early termination of reverse link communications using ACK messages on forward link communications. For clarity, the method 1000 is described below with reference to the base station 105 shown in FIGS. 1, 2, 3A, 3B, 4A, 6, or 9. In one implementation, the ACK generating module 425 may execute one or more sets of codes to control the functional elements of the base station 105 to perform the functions described below.

At block 1005, an event may be detected that indicates a condition of the forward link in an M2M wireless WAN. The event may include detecting a number of copies of a packet transmitted on the reverse link. The event may also include receiving a signal on the reverse link which may indicate the condition of the forward link.

At block 1010, a data rate may be selected to transmit the ACK message. In one configuration, the selection of the data rate may be based at least in part on the detected event that indicates the condition of the forward link. In one example, the data rate may be selected from a number of ACKs inserted into a single ACK packet. The ACK packet may be transmitted at 10 kilo bits per second (kbps). In another example, the ACK packet may be transmitted at 20 kbps.

At block 1015, the ACK message may be transmitted on the forward link in the M2M wireless WAN according to the selected data rate. The ACK message, when received, may serve to initiate early termination of transmissions on the reverse link.

Therefore, the method 1000 may provide for efficient management of early termination on the reverse link by selecting a data rate to transmit the ACK message. It should be noted that the method 1000 is just one implementation and that the operations of the method 1000 may be rearranged or otherwise modified such that other implementations are possible.

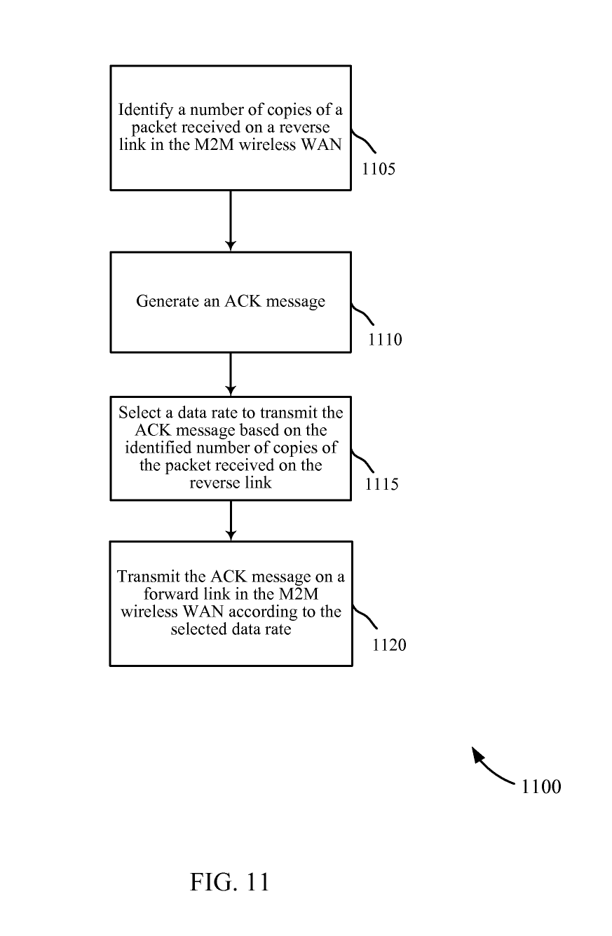

FIG. 11 is a flow chart illustrating one example of a method 1100 for managing early termination on the reverse link by selecting a data rate to transmit an ACK message based on a number of copies of a packet received on the reverse link. For clarity, the method 1100 is described below with reference to the base station 105 shown in FIGS. 1, 2, 3A, 3B, 4A, 6, or 9. In one implementation, the ACK generating module 425 may execute one or more sets of codes to control the functional elements of the base station 105 to perform the functions described below.

At block 1105, a number of copies of a packet that are received on a reverse link may be identified. The copies of the packet may be received in an M2M wireless WAN. At block 1110, an ACK message may be generated. The ACK message may be generated upon successfully decoding the packet transmitted on the reverse link. At block 1115, a data rate may be selected to transmit the ACK message. The data rate may be selected based on the identified number of copies of the packet received on the reverse link. In one embodiment, as the number of identified copies increases, the selected data rate may decrease. At block 1120, the ACK message may be transmitted on a forward link in the M2M wireless WAN according to the selected data rate. In one example, the ACK message may be transmitted during an ACK slot of a forward link frame. The ACK message may be transmitted in an ACK channel, which may be a common or shared channel.

Therefore, the method 1100 may provide for selecting a data rate to transmit an ACK message based on a number of copies of a packet received on the reverse link. It should be noted that the method 1100 is just one implementation and that the operations of the method 1100 may be rearranged or otherwise modified such that other implementations are possible.

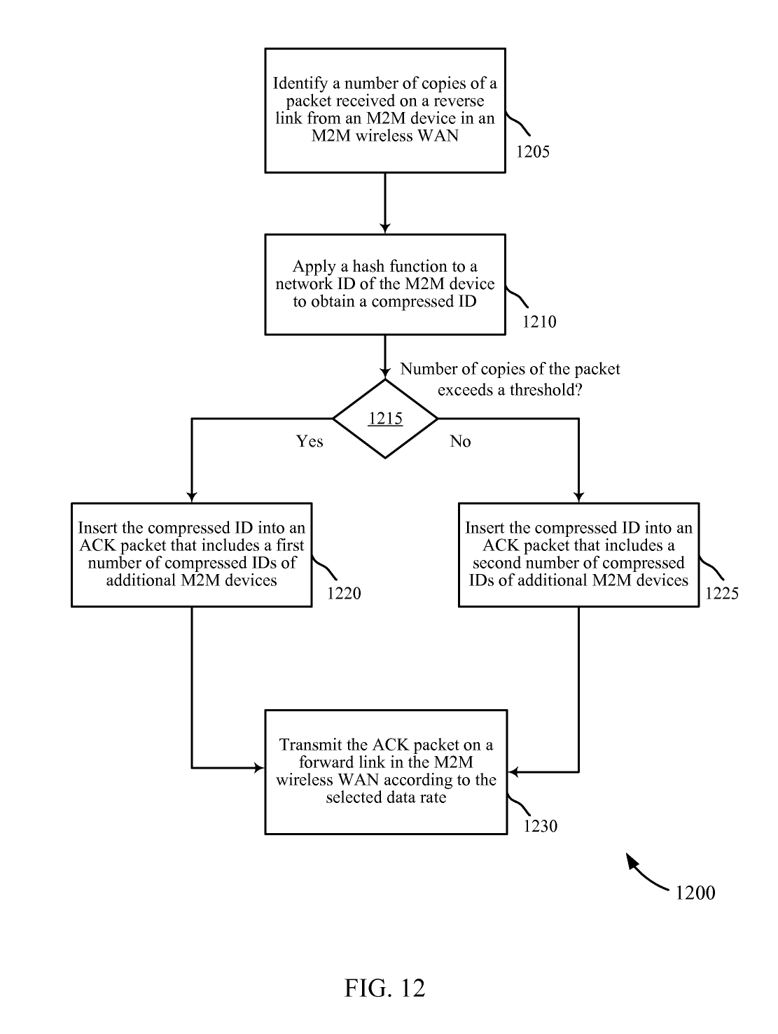

FIG. 12 is a flow chart illustrating one example of a method 1200 for managing reverse link communications by transmitting ACKs on the forward link at different data rates and on a random access channel. For clarity, the method 1200 is described below with reference to the base station 105 shown in FIGS. 1, 2, 3A, 3B, 4A, 6, or 9. In one implementation, the ACK generating module 425 may execute one or more sets of codes to control the functional elements of the base station 105 to perform the functions described below.

At block 1205, a number of copies of a packet received on a reverse link may be identified. The copies may be received from an M2M device 115 in an M2M wireless WAN. At block 1210, a hash function may be applied to a network ID of the M2M device 115 that transmitted the copies of the packet on the reverse link. The hash function may be applied to obtain a compressed ID from the network ID. The compressed ID may represent an ACK message that may be transmitted to the M2M device 115 to notify the device 115 that the packet has been successfully received. Upon receiving the ACK, the M2M device 115 may cease transmission of additional copies of the packet.

At block 1215, a determination may be made as to whether the number of copies of the packet exceeds a threshold. For example, if channel conditions between the M2M device 115 and a base station 105 are not favorable, the M2M device 115 may transmit more copies of the packet than if the channel conditions were favorable. If the base station 105 requires a high number of copies to be received on the reverse link before the base station 105 is able to decode the packet, the base station 105 may determine that channel conditions on the reverse link and the forward link are not ideal. Thus, if the number of copies exceeds the threshold, the compressed ID (i.e., an ACK) may be inserted, at block 1220, into an ACK packet that includes a first number of compressed IDs of additional M2M devices. If, however, the number of copies of the packet does not exceed the threshold, at block 1225, the compressed ID may be inserted into an ACK packet that includes a second number of compressed IDs of additional M2M devices. The number of compressed IDs in an ACK packet effectively selects the data rate at which the ACK packet is transmitted on the common channel. For example, the ACK packet may be transmitted during an ACK slot of 5 ms of a forward link frame. An ACK packet with three compressed IDs that is transmitted during a 5 ms slot is transmitted at a lower data rate than an ACK packet with six compressed IDs that is also transmitted during a 5 ms slot. As a result, if channel conditions for the forward link are favorable, ACKs may be transmitted at a higher data rate, which may lead to M2M devices terminating transmissions on the reverse link at an earlier time.

In one configuration, at block 1230, the ACK packet may be transmitted on the forward link of the M2M wireless WAN. The ACK packet may be transmitted according to the selected data rate, which is based in part on the number of compressed IDs included in the ACK packet. Each compressed ID (i.e., ACK message) in the ACK packet may be addressed to a different M2M device 115.

Therefore, the method 1200 may provide for efficient termination of communications on the reverse link by altering the data rate of ACK transmissions based on the conditions of the forward link. It should be noted that the method 1200 is just one implementation and that the operations of the method 1200 may be rearranged or otherwise modified such that other implementations are possible.

Techniques described herein may be used for various wireless communications systems such as M2M systems, cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies for multiple access in a wireless system such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for wireless communication in a machine-to-machine (M2M) wireless Wide Area Network (WAN), comprising:
detecting an event that indicates a condition of a forward link in the M2M wireless WAN;
selecting a data rate to transmit an acknowledgment (ACK) message, the selection of the data rate based at least in part on the detected event that indicates the condition of the forward link; and
transmitting the ACK message on the forward link in the M2M wireless WAN according to the selected data rate.

2. The method of claim 1, wherein selecting the data rate to transmit the ACK message comprises:
determining whether a number of copies of a packet received on a reverse link exceeds a threshold; and
upon determining that the number of copies of the packet exceeds the threshold, inserting the ACK message into a first ACK packet, the first ACK packet including a first number of ACK messages.

3. The method of claim 2, wherein selecting the data rate to transmit the ACK message comprises:
upon determining that the number of copies of the packet fails to exceed the threshold, inserting the ACK message into a second ACK packet, the second ACK packet including a second number of ACK messages, the second number of ACK messages being greater than the first number of ACK messages.

4. The method of claim 2, wherein each of the ACK messages in the first and second ACK packets is addressed to a different M2M device in the M2M wireless WAN.

5. The method of claim 1, wherein detecting an event comprises:
identifying a number of copies of a packet received on a reverse link in the M2M wireless WAN.

6. The method of claim 5, further comprising:
generating the ACK message upon receiving at least one copy of the packet on the reverse link.

7. The method of claim 6, wherein generating the ACK message comprises:
applying a hash function to an identifier (ID) of an M2M device that sent the at least one copy of the packet on the reverse link to obtain a compressed ID of the M2M device.

8. The method of claim 7, wherein the compressed ID comprises the ACK message.

9. The method of claim 7, wherein the hash function is applied to a network ID of the M2M device.

10. The method of claim 1, further comprising:
identifying a time slot of a physical layer frame; and
transmitting ACK message during the identified time slot.

11. The method of claim 10, wherein transmitting the ACK message comprises:
transmitting the ACK message during an ACK time slot of a forward link frame using an ACK channel.

12. The method of claim 11, wherein the ACK channel comprises a common or shared channel.

13. A base station configured for wireless communication in a machine-to-machine (M2M) wireless Wide Area Network (WAN), comprising:
a processor;
memory in electronic communication with the processor; and
instructions stored in the memory, the instructions being executable by the processor to:
detect an event that indicates a condition of a forward link in the M2M wireless WAN;
select a data rate to transmit an acknowledgment (ACK) message, the selection of the data rate based at least in part on the detected event that indicates the condition of the forward link; and
transmit the ACK message on the forward link in the M2M wireless WAN according to the selected data rate.

14. The base station of claim 13, wherein the instructions to select the data rate to transmit the ACK message are further executable by the processor to:
determine whether a number of copies of a packet received on a reverse link exceeds a threshold;
upon determining that the number of copies of the packet exceeds the threshold, insert the ACK message into a first ACK packet, the first ACK packet including a first number of ACK messages.

15. The base station of claim 14, wherein the instructions to select the data rate to transmit the ACK message are further executable by the processor to:
upon determining that the number of copies of the packet fails to exceed the threshold, insert the ACK message into a second ACK packet, the second ACK packet including a second number of ACK messages, the second number of ACK messages being greater than the first number of ACK messages.

16. The base station of claim 14, wherein each of the ACK messages in the first and second ACK packets is addressed to a different M2M device in the M2M wireless WAN.

17. The base station of claim 13, wherein the instructions to detect the event are further executable by the processor to:
identifying a number of copies of a packet received on a reverse link in the M2M wireless WAN.

18. The base station of claim 17, wherein the instructions are further executable by the processor to:
generate the ACK message upon receiving at least one copy of the packet on the reverse link.

19. The base station of claim 18, wherein the instructions to generate the ACK message are further executable by the processor to:
apply a hash function to an identifier (ID) of an M2M device that sent the at least one copy of the packet on the reverse link to obtain a compressed ID of the M2M device.

20. The base station of claim 19, wherein the compressed ID comprises the ACK message.

21. The base station of claim 19, wherein the hash function is applied to a network ID of the M2M device.

22. The apparatus of claim 13, wherein the instructions are further executable by the processor to:
identify a time slot of a physical layer frame; and
transmit the ACK message during the identified time slot.

23. The base station of claim 22, wherein the instructions to transmit the ACK message are further executable by the processor to:
transmit the ACK message during an ACK time slot of a forward link frame using an ACK channel.

24. The base station of claim 23, wherein the ACK channel comprises a common or shared channel.

25. An apparatus configured for wireless communication in a machine-to-machine (M2M) wireless Wide Area Network (WAN), comprising:
means for detecting an event that indicates a condition of a forward link in the M2M wireless WAN;
means for selecting a data rate to transmit an acknowledgment (ACK) message, the selection of the data rate based at least in part on the detected event that indicates the condition of the forward link; and
means for transmitting the ACK message on the forward link in the M2M wireless WAN according to the selected data rate.

26. The apparatus of claim 25, wherein the means for selecting the data rate to transmit the ACK message comprise:
means for determining whether a number of copies of a packet received on a reverse link exceeds a threshold;
upon determining that the number of copies of the packet exceeds the threshold, means for inserting the ACK message into a first ACK packet, the first ACK packet including a first number of ACK messages.

27. The apparatus of claim 26, wherein the means for selecting the data rate to transmit the ACK message comprise:
upon determining that the number of copies of the packet fails to exceed the threshold, means for inserting the ACK message into a second ACK packet, the second ACK packet including a second number of ACK messages, the second number of ACK messages being greater than the first number of ACK messages.

28. The apparatus of claim 26, wherein each of the ACK messages in the first and second ACK packets is addressed to a different M2M device in the M2M wireless WAN.

29. The apparatus of claim 25, wherein the means for detecting an event comprise:
means for identifying a number of copies of a packet received on a reverse link in the M2M wireless WAN.

30. The apparatus of claim 29, further comprising:
means for generating the ACK message upon receiving at least one copy of the packet on the reverse link.

31. The apparatus of claim 30, wherein the means for generating the ACK message comprise:
means for applying a hash function to an identifier (ID) of an M2M device that sent the at least one copy of the packet on the reverse link to obtain a compressed ID of the M2M device.

32. The apparatus of claim 31, wherein the compressed ID comprises the ACK message.

33. The apparatus of claim 31, wherein the hash function is applied to a network ID of the M2M device.

34. The apparatus of claim 25, further comprising:
means for identifying a time slot of a physical layer frame; and
means for transmitting the ACK message during the identified time slot.

35. The apparatus of claim 34, wherein the means for transmitting the ACK message comprise:
means for transmitting the ACK message during an ACK time slot of a forward link frame using an ACK channel.

36. The apparatus of claim 35, wherein the ACK channel comprises a common or shared channel.

37. A computer program product for managing wireless communication in a machine-to-machine (M2M) wireless Wide Area Network (WAN), the computer program product comprising a non-transitory computer-readable medium storing instructions executable by a processor to:
detect an event that indicates a condition of a forward link in the M2M wireless WAN;
select a data rate to transmit an acknowledgment (ACK) message, the selection of the data rate based at least in part on the detected event that indicates the condition of the forward link; and
transmit the ACK message on the forward link in the M2M wireless WAN according to the selected data rate.

38. The computer program product of claim 37, wherein the instructions to select a data rate are further executable by the processor to:
determine whether a number of copies of a packet received on a reverse link exceeds a threshold;
upon determining that the number of copies of the packet exceeds the threshold, insert the ACK message into a first ACK packet, the first ACK packet including a first number of ACK messages.

39. The computer program product of claim 38, wherein the instructions to select a data rate are further executable by the processor to:
upon determining that the number of copies of the packet fails to exceed the threshold, insert the ACK message into a second ACK packet, the second ACK packet including a second number of ACK messages, the second number of ACK messages being greater than the first number of ACK messages.

40. The computer program product of claim 37, wherein the instructions to detect an event are further executable by the processor to:
identify a number of copies of a packet received on a reverse link in the M2M wireless WAN.

41. The computer program product of claim 40, wherein the instructions are further executable by the processor to:
apply a hash function to an identifier (ID) of an M2M device that sent the at least one copy of the packet on the reverse link to obtain a compressed ID of the M2M device.

42. The computer program product of claim 41, wherein the compressed ID comprises the ACK message.

43. The computer program product of claim 41, wherein the hash function is applied to a network ID of the M2M device.
